(19) United States
(12) Patent Application Publication
(10) Pub. No.: US 2023/0096793 A1
(43) Pub. Date: Mar. 30, 2023

(54) Wearable Camera with Mobile Device Optical Coupling

(71) Applicant: RealWear, Inc., Vancouver, WA (US)

(72) Inventor: Chris Parkinson, Richland, WA (US)

(21) Appl. No.: 17/489,001

(22) Filed: Sep. 29, 2021

(51) Int. Cl. H04N 7/18; H04N 5/232

(52) U.S. Cl. CPC H04N 7/183; H04N 5/23229; H04N 5/23293; H04M 1/0264

(57) ABSTRACT

A wearable camera with mobile device optical coupling provides hands-free point-of-view video-chat. The mobile device optical coupling is enabled by an optic transfer engine that comprises a communications bus, a video decoding module, a micro-display, and a housing. The communications bus initially receives optical sensor data from an optical sensing device (e.g., the wearable camera). Next, the video decoding module decodes the optical sensor data. The micro-display displays the decoded optical sensor data. The housing partially encloses the communications bus, the video decoding module, and the micro-display and has a mounting element that is configured to removably mount the optics couple to a computing device such that the micro-display is positioned in a field of view of another optical sensing device coupled to the computing device.

### BACKGROUND

Smart-phones and tablets typically have one or more built-in cameras. These cameras are used primarily to take snapshots or video clips. In addition, these cameras are also often used to facilitate 2-way (or more) video-chat with other users. For instance, iPhone and iOS® devices come with the built-in FaceTime® application that allows for easy and convenient video chat with other iOS® users using the existing built-in camera(s). Skype® is a popular alternative video-chat solution for iOS®, Android®, and Windows® devices, and a number of other zero-cost solutions are also available and also use the existing built-in camera(s) (e.g., Facebook®, Flickr®, Zoom, Microsoft® Teams, Instagram, remote mentor software, and the like).

However, existing video-chat applications are limited to using the existing built-in camera(s) of the smart-phone or tablet. This drawback requires the user to use one or more hands to operate the smart-phone or tablet, usually by holding the device up to eye-level in order to see the on-screen preview, while at the same time aiming the device at the subject matter. For face-to-face video chats, this type of operation works well. But, if the user is trying to film or show off subject matter in front of the user, it can be uncomfortable to hold the device up for the duration of the corresponding event being filmed. Currently, there are no conventional systems that enable a user to attach an external camera to a device (i.e., hands-free), and still be able to utilize a zero-cost video-chat solution.

### SUMMARY OF THE INVENTION

This summary is provided to introduce a selection of concepts in a simplified form that are further described below in the Detailed Description. This summary is not intended to identify key or essential features of the claimed subject matter, nor is it intended to be used as an aid in determining the scope of the claimed subject matter.

At a high level, embodiments described herein, include a wearable camera with mobile device optical coupling. The mobile device optical coupling is enabled by an optic transfer engine that comprises a communications bus, a video decoding module, a micro-display, and a housing. The communications bus initially receives optical sensor data from an optical sensing device (e.g., the wearable camera). Next, the video decoding module decodes the optical sensor data. The micro-display displays the decoded optical sensor data. The housing partially encloses the communications bus, the video decoding module, and the micro-display and has a mounting element that is configured to removably mount the optics couple to a computing device such that the micro-display is positioned in a field of view of another optical sensing device coupled to the computing device.

Additional objects, advantages, and novel features of the invention will be set forth in part in the description which follows, and in part will become apparent to those skilled in the art upon examination of the following, or can be learned by practice of the invention.

### BRIEF DESCRIPTION OF THE DRAWINGS

The features of the invention noted above are explained in more detail with reference to the embodiments illustrated in the attached drawing figures, in which like reference numerals denote like elements, in which FIGS. 1-10 illustrate embodiments of the present invention and in which:

FIG. 1 provides a block diagram of an exemplary optic transfer engine, in accordance with some implementations of the present disclosure;

FIG. 2 shows a user employing a wearable device with mobile device optical coupling, in accordance with some of the implementations of the present disclosure;

FIG. 3 shows a display of the mobile device coupled to the wearable device of FIG. 2, in accordance with some of the implementations of the present disclosure;

FIG. 4A shows a first perspective of an exploded view of the components of the optic transfer engine stacked together and mounted to the back of the mobile device, in accordance with some of the implementations of the present disclosure;

FIG. 4B shows a second perspective of an exploded view of the components of the optic transfer engine stacked together and mounted to the back of the mobile device, in accordance with some implementations of the present disclosure;

FIG. 5 shows an exploded side-view of the components of the optic transfer engine stacked together and mounted at an angle relative to the back of the mobile device, in accordance with some implementations of the present disclosure;

FIG. 6 shows an exploded side-view of the components of the optic transfer engine stacked together and mounted with a focus element at an angle relative to the back of the mobile device, in accordance with some implementations of the present disclosure;

FIG. 7 provides a schematic diagram showing an exemplary wearable camera with a USB mobile device optical coupling system, in accordance with some implementations of the present disclosure;

FIG. 8 provides a schematic diagram showing an exemplary wearable camera with a wireless mobile device optical coupling system, in accordance with some implementations of the present disclosure; and

FIG. 9 provides a block diagram of an exemplary computing device in which some implementations of the present disclosure can be employed.

### DETAILED DESCRIPTION

As described in the Background, existing video-chat applications are limited to using the existing built-in camera(s) of the smart-phone or tablet. This drawback requires a user to use one or more hands to operate the smart-phone or tablet, usually by holding the device up to eye-level in order to see the on-screen preview, while at the same time aiming the device at the subject matter. For face-to-face video chats, this type of operation works well. But, if the user is trying to film or show off subject matter in front of the user, it can be uncomfortable to hold the device up for the duration of the corresponding event being filmed. Currently, there are no conventional systems that enable a user to attach an external camera to a device (i.e., hands-free), and still be able to utilize a zero-cost video-chat solution.

Embodiments of the present invention include a wearable camera with mobile device optical coupling. The mobile device optical coupling is enabled by an optic transfer engine that comprises a communications bus, a video decoding module, a micro-display, and a housing. The communications bus initially receives optical sensor data from an optical sensing device (e.g., the wearable camera). Next, the video decoding module decodes the optical sensor data. The micro-display displays the decoded optical sensor data. The housing partially encloses the communications bus, the video decoding module, and the micro-display and has a mounting element that is configured to removably mount the optics couple to a computing device such that the micro-display is positioned in a field of view of another optical sensing device coupled to the computing device.

Wearable cameras include, but are not otherwise limited to head-mounted display (HMD) devices. Although many of the various embodiments discussed herein are directed to wearable cameras, it should be understood that the various methods and systems for providing visual elements are not limited to wearable devices, such as HMD devices. Rather, the various methods may be employed in other computing devices, such as but not limited to networked camera devices that include one or more cameras, or virtually any computing device that includes at least one cameras.

Accordingly, in one aspect, an embodiment is directed to a digital optics transfer device. The device comprises an optic transfer engine. The optic transfer engine has a communications bus configured to receive optical sensor data from an optical sensing device. The optic transfer engine also has a video decoding module configure to decode the optical sensor data. The optic transfer engine further has a micro-display configured to display the decoded optical sensor data. The device also comprises a housing that at least partially encloses the communications bus, the video decoding module, and the micro-display. The housing has a mounting element configured to removably mount the optic transfer engine to a computing device such that the micro-display is positioned in a field of view of another optical sensing device coupled to the computing device.

In another aspect of the invention, an embodiment of the present invention is directed to at least one computer storage media having instructions thereon that, when executed by at least one process of a computing system, cause the computing system to: communicate, to a remote device, a copy of a first electronic image that was captured via a sensor with a first resolution, wherein the copy is communicated at a second resolution less than the first resolution; generate an instruction to capture a second electronic image utilizing a portion of the sensor with the first resolution; cause the sensor to capture the second electronic image in response to the generated instruction; and provide for display, to the remote device, the second electronic image at the second resolution.

In a further aspect, an embodiment is directed to a computerized system that includes at least one processor and at least one computer storage media storing computer-useable instructions that, when executed by the at least one processor, causes the at least one processor to: communicate, to a remote device, a copy of a first electronic image that was captured via a sensor with a first resolution, wherein the copy is communicated at a second resolution less than the first resolution; receive, from the remote device, a selection that corresponds to a user-selected area of the communicated copy, wherein the user-selected area further corresponds to a portion of the sensor; based on the received selection, generate an instruction to capture a second electronic image utilizing the portion of the sensor with the first resolution; cause the sensor to capture the second electronic image in response to the generated instruction; and provide for display, to the remote device, the second electronic image at the second resolution.

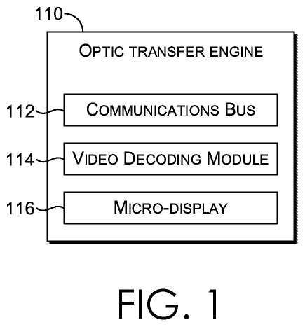

FIG. 1 provides a block diagram of an exemplary optic transfer engine 110, in accordance with some implementations of the present disclosure. Generally, optic transfer engine 110 utilizes a micro-display that is placed in front of, or nearby, a standard smart-phone camera lens such that contents of the micro-display are projected into the smart-phone camera. In this way, the view from the smart-phones camera can be controlled by altering the content on the micro-display. More simply, a user wearing a wearable device may share video in a field-of-view of the wearable device with another user via a video-chat solution running on the smart-phone.

Optic transfer engine 110 comprises communications bus 112, video decoding module 114, and micro-display 116. Communications bus 112 is generally configured to receive optical sensor data from an optical sensing device. For example, an optical sensing device from an external camera, such as a camera of a wearable device, may receive optical sensor data when a user is employing the external camera to capture video of the environment or an event around the user. When coupled to a computing device, such as a smart-phone, communications bus 112 receives the optical sensor data from the external camera. In embodiments, the communications bus 112 includes one of a wired communications module or a wireless communications module.

Video decoding module 114 is generally configured to decode the optical sensor data. Following the same example above, the external camera initially captures raw image files. The raw image files are typically encoded for compression purposes. Since the communications bus 112 receives encoded data form the external camera, it needs to be decoded in order to be displayed. In other words, video decoding module 114 receives the encoded data and decodes the encoded data so the decoded data can be displayed.

Micro-display 116 is generally configured to display the decoded optical sensor data. In embodiments, a housing at least partially encloses the communications bus 112, the video decoding module 114, and the micro-display 116. The housing includes a mounting element that is configured to removably mount the optic transfer engine 110 to a computing device such that the micro-display 116 is positioned in a field of view of another optical sensing device coupled to the computing device. In this way, the housing enables the micro-display 116 to be mounted to the smart-phone so the micro-display 116 is positioned in a field of view of the smart-phone camera. As such, the housing may present an opening through which the micro-display is viewable (i.e., by the smart-phone camera). This enables the micro-display 116 to be fixed in a position that is parallel to the opening.

Generally, micro-displays 116 range in size and resolution from 200×100 pixels in a 0.2 inch diagonal up to 4000×4000 pixels in a 1.0 inch diagonal. The optic transfer engine 110 allows for any size micro-display 116 to be used as long as the appropriate lens structure is in place to accurately convey the micro-display 116 information to the camera lens.

In some embodiments, the mounting element is coupled to the housing adjacent to at least a portion of the opening. The mounting element may include a magnet configured to magnetically attach the optic transfer engine to a body or a case of the computing device. Additionally or alternatively, the mounting element may include a spring element to attach the optic transfer engine to a body or a case of the computing device. In other embodiments, the optic transfer engine may be integrated into the body or case of the computing device, or into the camera of the computing device, itself. Without the optic transfer engine mounted, the smart-phone behaves as normal. In other words, the rear-facing camera views whatever it is pointed at by the user. When the optic transfer engine is mounted, however, the smart-phone camera is tricked into seeing whatever image is displayed on the micro-display.

Typical smart-phone cameras are focused at a depth less than twelve inches. This lens structure allows the micro-display information to be accurately conveyed into the camera lens. However, it may be advantageous in some embodiments to include a focus element in the optic transfer engine stack. Generally, the focus element is configured to adjust a focus of the micro-display. For example, the focus element may enable precise image tuning or account for differences in camera lens from one smart-phone model to the next.

In some embodiments, optic transfer engine 110 includes a mirror that is fixed at a 45-degree angle relative to the opening. In this configuration, the micro-display is fixed at a 90-degree angle relative to the opening. Moreover, the mirror is configured to convey an output of the micro-display that is parallel to the opening.

The optic transfer engine 110 includes, in some embodiments, a power source. The power source is configured to supply electricity to at least the video decoding module and the micro-display. For example, the power source may include a rechargeable battery. A set of charging terminals may be presented on the housing and configured to relay an electrical current from an external power source to the rechargeable battery.

Although not depicted in FIG. 1, an optical sensing device of an external camera, as described above and referring to a camera of a wearable device, may receive optical sensor data when a user is employing the external camera to capture video of the environment or an event around the user. The optical sensing device may have an optical sensor configured to generate the optical sensor data. The optical sensing device may also have a video encoding module configured to encode the optical sensor data. The optical sensing device may further have another communications bus (i.e., different from the communications bus of the optic transfer engine 110) configured to send the optical sensor data to the optic transfer engine 110.

In embodiments, the optical sensing device may have an inertial measurement unit (IMU) configured to detect motion of the optical sensing device. In this configuration, the video encoding module may be further configured to encode a portion of the optical sensor data that is selected based on the detected motion. The optical sensing device may additional have a digital viewfinder that is configured to display the decoded optical sensor data. Moreover, the optical sensing device may have a LED flashlight that faces in a direction away from the optical sensor.

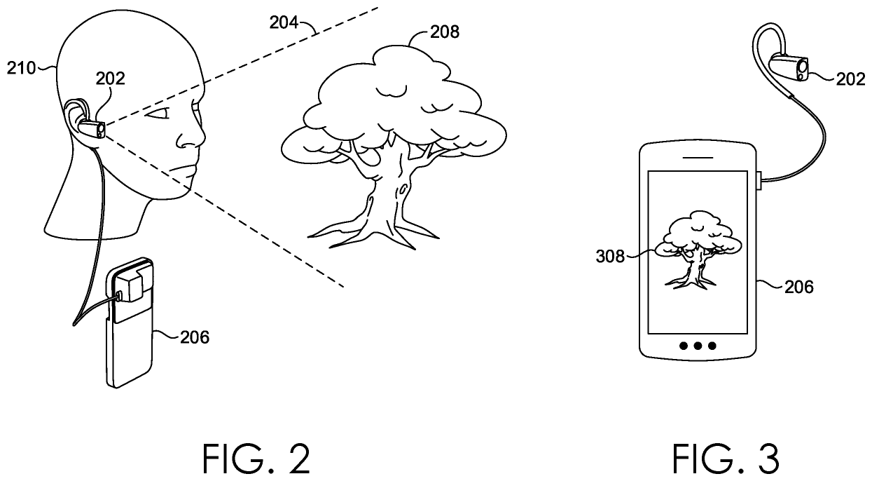

Turning now to FIG. 2, a user employing a wearable device with mobile device optical coupling is illustrated, in accordance with some of the implementations of the present disclosure. As shown, the user 210 is wearing a wearable device 202 that is coupled or tethered to a mobile device 206, such as by using a USB cable. The field-of-vision 204 of an optical sensing device of the wearable device 202 is depicted. In this example, a tree represents the illustrated subject 208 of the field-of vision 204 of the optical sensing device.

Referring now to FIG. 3, a display of the mobile device coupled to the wearable device of FIG. 2 is illustrated, in accordance with some of the implementations of the present disclosure. The mobile device 206 remains coupled or tethered to the wearable device 202. As shown, by utilizing the optic transfer engine in connection with the mobile device 206, the display 308 of the mobile device 206 provides the decoded data that has been captured, encoded, and communicated by the optical sensing device of the wearable device 202. In this case, the display 308 is the field-of-vision captured by the optical sensing device of the wearable device 202, as illustrated in FIG. 2.

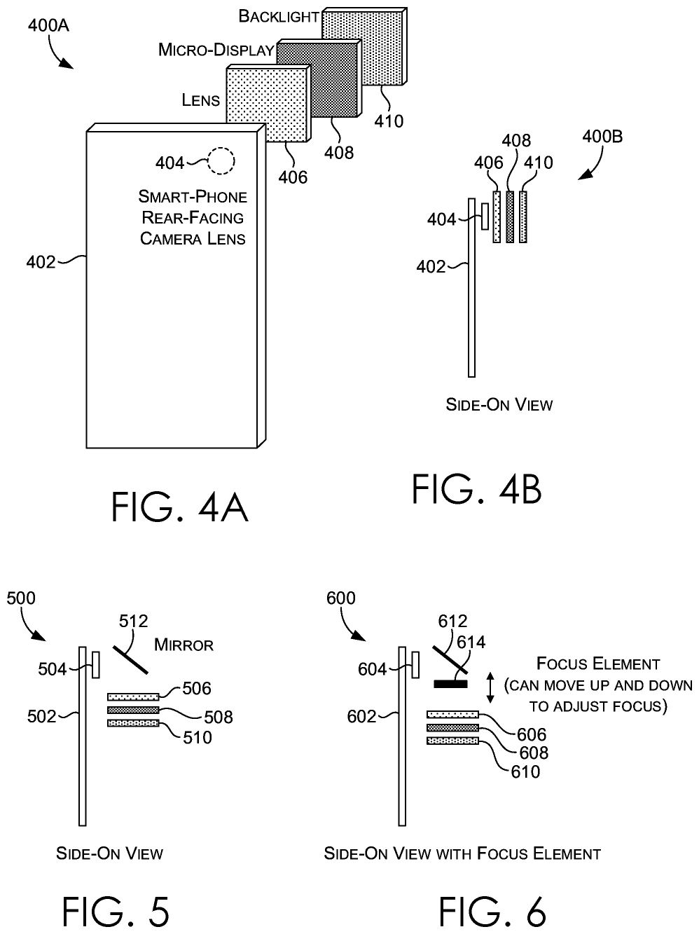

In FIG. 4A, a first perspective of an exploded view 400A of the components of the optic transfer engine stacked together and mounted to the back of the mobile device is shown, in accordance with some of the implementations of the present disclosure. As shown in its simplest form by view 400A, optic transfer engine includes lens 406, micro-display 408, and backlight 410. Lens 406, micro-display 408, and backlight 410 are stacked together and mounted in front of the rear-facing camera lens 404 of mobile device 402. Although illustrated and described as including backlight 410, it is contemplated and within the scope of the present disclosure that some implementations of the optic transfer engine do not require backlight 410. For example, in a microLED implementation, RGB projectors are utilized to project the image and a separate backlight is not needed.

FIG. 4B shows a second perspective of an exploded view 400B of the components of the optic transfer engine stacked together and mounted to the back of the mobile device, in accordance with some implementations of the present disclosure. Similar to view 400A and as shown in view 400B, optic transfer engine includes lens 406, micro-display 408, and backlight 410. Lens 406, micro-display 408, and backlight 410 are stacked together and mounted in front of the rear-facing camera lens 404 of mobile device 402.

In each arrangement, the components of the optic transfer engine are removably mounted to the mobile device 402 so that video content displayed on the micro-display 408 is projected into the rear-facing camera lens 404 of smart-phone 402. In various embodiments, the distances between the rear-facing camera lens 404 of smart-phone 402 and the components of the optic transfer engine are pre-configured in accordance with fixed specifications of the mobile device 402 or are configurable in accordance with configurable specifications of the mobile device 402. For clarity, specifications may include focus, size, resolution, brightness, exposure, contrast, or other image/video properties.

Turning now to FIG. 5, an exploded side-view 500 of the components of the optic transfer engine is shown stacked together and mounted at an angle relative to the back of the mobile device, in accordance with some implementations of the present disclosure. As shown by view 500, a more compact arrangement of the optic transfer engine is depicted. In this arrangement, the optic transfer engine includes lens 506, micro-display 508, backlight 510, and mirror 512. The lens 506, micro-display 508, and backlight 510 are positioned substantially perpendicular, or at an approximately 90-degree angle, relative to the lens 504 of mobile device 502. Mirror 512 is fixed at an approximately 45-degree angle, relative to the lens 504 of mobile device 502.

Referring now to FIG. 6, an exploded side-view of the components of the optic transfer engine stacked together and mounted with a focus element at an angle relative to the back of the mobile device is shown, in accordance with some implementations of the present disclosure. Similar to view 500 and as shown in view 600, optic transfer engine includes lens 606, micro-display 608, backlight 610, and mirror 612. As in FIG. 5, the lens 606, micro-display 608, and backlight 610 of FIG. 6 are positioned substantially perpendicular, or at an approximately 90-degree angle, relative to the lens 604 of mobile device 602.

Mirror 612 is fixed at an approximately 45-degree angle, relative to the lens 604 of mobile device 602. Additionally, focus element 614 is positioned at a substantially similar angle as the lens 606, micro-display 608, and backlight 610, and is able to move up towards the lens 604 of mobile device or down towards the lens 606, micro-display 608, and backlight 610. Focus element 614 is configured to adjust a focus of the micro-display. By adding focus element 614 to the optic stack, the optic transfer engine is able to accommodate precise image tuning to adjust for differences in lens from one mobile device model to the next.

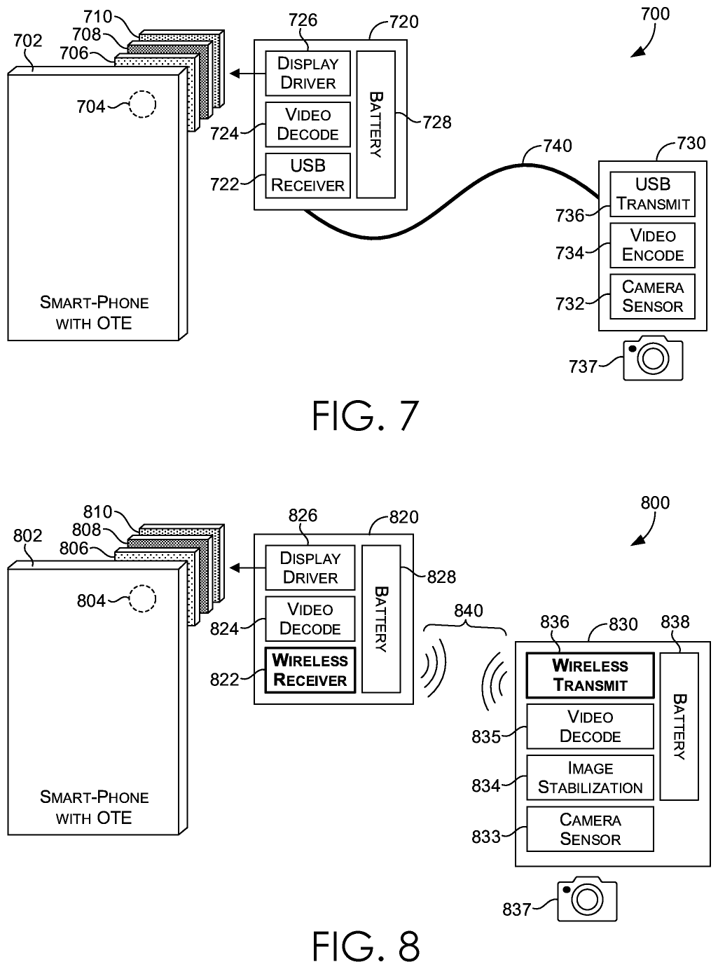

In FIG. 7, a schematic diagram 700 showing an exemplary wearable camera with a USB mobile device optical coupling system is shown, in accordance with some implementations of the present disclosure. The camera device 737 includes a USB camera acquisition system 730. The USB camera acquisition system 730 includes a camera sensor 732, a video encoder 734, and a USB transmitter 736. In practice, the USB camera acquisition system 730 enables the camera device 737 to capture live video, encode it, and transmit it down the USB cable to the optic transfer engine 720. Power for this system may be provided by battery 728 in the optic transfer engine 720, transmitted along the USB cable. Although described in FIG. 7 as USB, it is contemplated and within the scope of the claims that any wired connection, transmitter, and receiver may be utilized by camera device and optic transfer engine.

Optic transfer engine 720 receives the encoded video at USB receiver 722, decodes the video at video decoder 724, and provides real-time video frames into the display driver 726. The video frames are projected into the lens 704 of mobile device 702 via the backlight 710, the micro-display 708, and lens 706 of optic transfer engine 720.

FIG. 8 provides a schematic diagram 800 showing an exemplary wearable camera with a wireless mobile device optical coupling system, in accordance with some implementations of the present disclosure. As shown in FIG. 8, the camera device 837 includes a wireless camera acquisition system 830. The wireless camera acquisition system 830 includes a camera sensor 832, a video encoder 834, and a wireless transmitter 836. In practice, the wireless camera acquisition system 830 enables the camera device 837 to capture live video, encode it, and transmit it wireless to the optic transfer engine 820. Power for this system may be provided by battery 828 in the optic transfer engine 820 and battery 838 in the wireless camera acquisition system 830. Exemplary wireless systems may include 802.11a/b/g/n operating at 2.4 GHz or 5 GHz.

Optic transfer engine 820 receives the encoded video at wireless receiver 822, decodes the video at video decoder 824, and provides real-time video frames into the display driver 826. The video frames are projected into the lens 804 of mobile device 802 via the backlight 810, the micro-display 808, and lens 806 of optic transfer engine 820.

In embodiments, the camera acquisition systems of FIGS. 7 and 8 may include additional features. For example, a set of standard audio ear-buds with built-in microphone can be incorporated into the mobile device optical coupling system. Standard audio ear-buds with built-in microphone can be plugged into an audio jack of the mobile device. In this way, the external camera wearer may have full-duplex audio connection with the mobile device, and hence, the third party at the end of a video conversation.

In another example and, as shown in FIG. 8, the camera acquisition system includes an image stabilization module 834 to reduce the image-shaking observed when a person is walking with a body-worn camera. The image stabilization system may comprise a 9-axis accelerometer that accurately detects motion. Motion information may be fed into the video encoder module 834 such that only a subset of the full camera image is ever encoded and communicated to the optic transfer engine 820. As the wearer moves around, the subset of captured images also moves in a way to counter the body movement.

In yet another example, a small digital viewfinder may be incorporated with the wearable camera. The viewfinder comprises an additional micro-display with backlight and lens and is driven directly from the camera sensor and image stabilization modules to accurately convey the video image captured by the camera sensor. Without such a viewfinder, the user has refer to the smart-phone screen to understand what the camera sensor is really viewing. With the viewfinder in place, and worn next to the user's eye, the user will be able to glance at the display to accurately understand which way his camera is facing. In embodiments, the viewfinder manifests as a near-eye micro-display, worn approximately 1-2 inches from one eye, usually below or above the line of sight.

In another embodiment, the wearable end of the external camera may be fitted with a micro-controller and Bluetooth module. In coordination with software installed on the mobile device that enables the content to be generated and sent to the viewfinder for the display using standard Bluetooth profiles (e.g., SPP), the viewfinder can be fed other content in addition to its live camera preview. For example, such content may include instructions, notes, messages, and the like provided by a third party on the other end of the video-chat.

Additionally, or alternatively, the wearable portion of the external camera can be fitted with an LED flashlight. The LED flashlight may be configured to point in the same direction as the camera lens and help illuminate the field-of-view, as may be necessary in low-light conditions. The LED illumination may be controlled by an on/off switch on the wearable device itself, or may be controlled by the third-party viewer if the light conditions of the video-chat are not acknowledged by the wearer of the external camera.

Having described embodiments of the present invention, an example operating environment in which embodiments of the present invention may be implemented is described below in order to provide a general context for various aspects of the present invention.

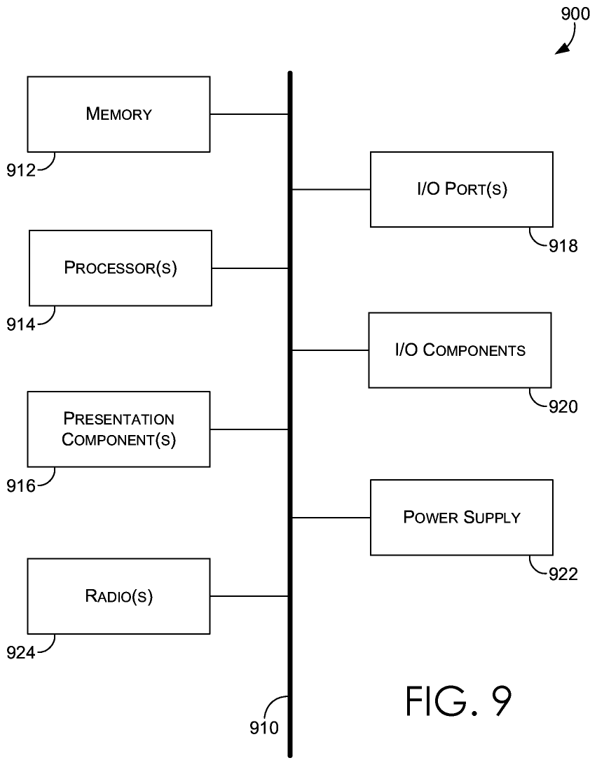

FIG. 9 provides a block diagram of an exemplary wearable device 900 in which some implementations of the present disclosure may be employed. Any of the various embodiments of wearable devices discussed herein, including but not limited to HMD device 120 of FIG. 1, may include similar features, components, modules, operations, and the like as wearable device 900. In this example, wearable device 900 may be enabled for wireless two-way communication device with voice and data communication capabilities. Such wearable devices communicate with a wireless voice or data network 950 using a suitable wireless communications protocol. Wireless voice communications are performed using either an analog or digital wireless communication channel. Data communications allow the wearable device 900 to communicate with other computer systems via the Internet. Examples of wearable devices that are able to incorporate the above described systems and methods include, for example, a data messaging device, a two-way pager, a cellular telephone with data messaging capabilities, a wireless Internet appliance or a data communication device that may or may not include telephony capabilities.

The illustrated wearable device 900 is an exemplary wearable device that includes two-way wireless communications functions. Such wearable devices incorporate communication subsystem elements such as a wireless transmitter 910, a wireless receiver 912, and associated components such as one or more antenna elements 914 and 916. A digital signal processor (DSP) 908 performs processing to extract data from received wireless signals and to generate signals to be transmitted. The particular design of the communication subsystem is dependent upon the communication network and associated wireless communications protocols with which the device is intended to operate.

The wearable device 900 includes a microprocessor 902 that controls the overall operation of the wearable device 900. The microprocessor 902 interacts with the above described communications subsystem elements and also interacts with other device subsystems such as flash memory 906, random access memory (RAM) 904, auxiliary input/output (I/O) device 938, data port 928, display 934, keyboard 936, speaker 932, microphone 930, a short-range communications subsystem 920, a power subsystem 922, and any other device subsystems.

A battery 924 is connected to a power subsystem 922 to provide power to the circuits of the wearable device 900. The power subsystem 922 includes power distribution circuitry for providing power to the wearable device 900 and also contains battery charging circuitry to manage recharging the battery 924. The power subsystem 922 includes a battery monitoring circuit that is operable to provide a status of one or more battery status indicators, such as remaining capacity, temperature, voltage, electrical current consumption, and the like, to various components of the wearable device 900.

The data port 928 is able to support data communications between the wearable device 900 and other devices through various modes of data communications, such as high speed data transfers over an optical communications circuits or over electrical data communications circuits such as a USB connection incorporated into the data port 928 of some examples. Data port 928 is able to support communications with, for example, an external computer or other device.

Data communication through data port 928 enables a user to set preferences through the external device or through a software application and extends the capabilities of the device by enabling information or software exchange through direct connections between the wearable device 900 and external data sources rather than via a wireless data communication network. In addition to data communication, the data port 928 provides power to the power subsystem 922 to charge the battery 924 or to supply power to the electronic circuits, such as microprocessor 902, of the wearable device 900.

Operating system software used by the microprocessor 902 is stored in flash memory 906. Further examples are able to use a battery backed-up RAM or other non-volatile storage data elements to store operating systems, other executable programs, or both. The operating system software, device application software, or parts thereof, are able to be temporarily loaded into volatile data storage such as RAM 904. Data received via wireless communication signals or through wired communications are also able to be stored to RAM 904.

The microprocessor 902, in addition to its operating system functions, is able to execute software applications on the wearable device 900. A predetermined set of applications that control basic device operations, including at least data and voice communication applications, is able to be installed on the wearable device 900 during manufacture. Examples of applications that are able to be loaded onto the device may be a personal information manager (PIM) application having the ability to organize and manage data items relating to the device user, such as, but not limited to, e-mail, calendar events, voice mails, appointments, and task items.

Further applications may also be loaded onto the wearable device 900 through, for example, the wireless network 950, an auxiliary I/O device 938, Data port 928, short-range communications subsystem 920, or any combination of these interfaces. Such applications are then able to be installed by a user in the RAM 904 or a non-volatile store for execution by the microprocessor 902.

In a data communication mode, a received signal such as a text message or web page download is processed by the communication subsystem, including wireless receiver 912 and wireless transmitter 910, and communicated data is provided to the microprocessor 902, which is able to further process the received data for output to the display 934, or alternatively, to an auxiliary I/O device 938 or the data port 928. A user of the wearable device 900 may also compose data items, such as e-mail messages, using the keyboard 936, which is able to include a complete alphanumeric keyboard or a telephone-type keypad, in conjunction with the display 934 and possibly an auxiliary I/O device 938. Such composed items are then able to be transmitted over a communication network through the communication subsystem.

For voice communications, overall operation of the wearable device 900 is substantially similar, except that received signals are generally provided to a speaker 932 and signals for transmission are generally produced by a microphone 930. Alternative voice or audio I/O subsystems, such as a voice message recording subsystem, may also be implemented on the wearable device 900. Although voice or audio signal output is generally accomplished primarily through the speaker 932, the display 934 may also be used to provide an indication of the identity of a calling party, the duration of a voice call, or other voice call related information, for example.

Depending on conditions or statuses of the wearable device 900, one or more particular functions associated with a subsystem circuit may be disabled, or an entire subsystem circuit may be disabled. For example, if the battery temperature is low, then voice functions may be disabled, but data communications, such as e-mail, may still be enabled over the communication subsystem.

A short-range communications subsystem 920 provides for data communication between the wearable device 900 and different systems or devices, which need not necessarily be similar devices. For example, the short-range communications subsystem 920 includes an infrared device and associated circuits and components or a Radio Frequency based communication module such as one supporting Bluetooth® communications, to provide for communication with similarly-enabled systems and devices, including the data file transfer communications described above.

A media reader 960 connectable to an auxiliary I/O device 938 to allow, for example, loading computer readable program code of a computer program product into the wearable device 900 for storage into flash memory 906. One example of a media reader 960 is an optical drive such as a CD/DVD drive, which may be used to store data to and read data from a computer readable medium or storage product such as computer readable storage media 962. Examples of suitable computer readable storage media include optical storage media such as a CD or DVD, magnetic media, or any other suitable data storage device. Media reader 960 is alternatively able to be connected to the wearable device through the data port 928 or computer readable program code is alternatively able to be provided to the wearable device 900 through the wireless network 950.

Referring to FIG. 9, an exemplary operating environment for implementing embodiments of the present disclosure is shown and designated generally as computing device 900. Computing device 900 is but one example of a suitable computing environment and is not intended to suggest any limitation as to the scope of use or functionality of the inventive embodiments. Neither should the computing device 900 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 9, computing device 900 includes a bus 910 that directly or indirectly couples the following devices: memory 912, one or more processors 914, one or more presentation components 916, input/output (I/O) ports 918, input/output (I/O) components 1920, and an illustrative power supply 922. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 9 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer-storage media in the form of volatile and/or nonvolatile memory. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc. The I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

Many variations can be made to the illustrated embodiment of the present invention without departing from the scope of the present invention. Such modifications are within the scope of the present invention. Embodiments presented herein have been described in relation to particular embodiments which are intended in all respects to be illustrative rather than restrictive. Alternative embodiments and modifications would be readily apparent to one of ordinary skill in the art, but would not depart from the scope of the present invention.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

From the foregoing it will be seen that this invention is one well adapted to attain all ends and objects hereinabove set forth together with the other advantages which are obvious and which are inherent to the structure. It will be understood that certain features and subcombinations are of utility and may be employed without reference to other features and subcombinations. This is contemplated by and is within the scope of the invention.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B, and C).”

What is claimed is:

1. A digital optics transfer device comprising:
an optic transfer engine having:
a communications bus configured to receive optical sensor data from an optical sensing device;
a video decoding module configured to decode the optical sensor data; and
a micro-display configured to display the decoded optical sensor data; and
a housing that at least partially encloses the communications bus, the video decoding module, and the micro-display, the housing having a mounting element configured to removably mount the optic transfer engine to a computing device such that the micro-display is positioned in a field of view of another optical sensing device coupled to the computing device.

2. The device of claim 1, wherein the housing presents an opening through which the micro-display is viewable and fixed in a position that is parallel to the opening.

3. The device of claim 2, further comprising:
a focus element configured to adjust a focus of the micro-display.

4. The device of claim 2, wherein the mounting element is coupled to the housing adjacent to at least a portion of the opening.

5. The device of claim 4, wherein the mounting element includes a magnet configured to magnetically attach the optic transfer engine to a body or a case of the computing device.

6. The device of claim 2, further comprising:
a mirror that is fixed at a 45-degree angle relative to the opening, and wherein the micro-display is fixed at a 90-degree angle relative to the opening, wherein the mirror is configured to convey an output of the micro-display that is parallel to the opening.

7. The device of claim 1, further comprising:
a power source configured to supply electricity to at least the video decoding module and the micro-display.

8. The device of claim 7, wherein the power source includes a rechargeable battery.

9. The device of claim 8, further comprising:
a set of charging terminals presented on the housing and configured to relay an electrical current from an external power source to the rechargeable battery.

10. The device of claim 1, wherein the communications bus includes one of a wired communications module or a wireless communications module.

11. The system of claim 10, further comprising:
the optical sensing device having:
an optical sensor configured to generate the optical sensor data;
a video encoding module configured to encode the optical sensor data;
another communications bus configured to send the optical sensor data to the optic transfer engine.

12. The device of claim 11,
the optical sensing device further having:
an inertial measurement unit (IMU) configured to detect motion of the optical sensing device, and wherein the video encoding module is further configured to encode a portion of the optical sensor data, the portion being selected based on the detected motion.

13. The device of claim 11,
the optical sensing device further having:
a digital viewfinder configured to display the decoded optical sensor data.

14. The device of claim 11,
the optical sensing device further having:
a LED flashlight that is facing in a direction away from the optical sensor.

15. An optic transfer engine comprising:
a communications bus configured to receive optical sensor data encoded by an optical sensing device that is separate from the optic transfer engine;
a video decoding module configured to decode the optical sensor data;
a micro-display configured to display the decoded optical sensor data; and
a housing that at least partially encloses the communications bus and the video decoding module, and presents an opening through which the micro-display is exposed, the housing having a mounting element configured to removably mount the opening of the optic transfer engine to a computing device such that the micro-display is positioned in a field of view of another optical sensing device coupled to the computing device.

16. The optic transfer engine of claim 15, wherein the communications bus includes one of a USB port or a wireless receiver module.

17. The optic transfer engine of claim 15 further comprising:
a rechargeable power supply configured to power at least the video decoding module and the micro-display.

18. The optic transfer engine of claim 15, further comprising:
a focus element configured to adjust a focus of the micro-display.

19. The optic transfer engine of claim 15, further comprising:
a LED flashlight facing in a direction away from the optical sensor.

20. The optic transfer engine of claim 15, wherein the mounting element includes one of a magnet or a clip.
